(19) United States
(12) Patent Application Publication
(10) Pub. No.: US 2018/0291516 A1
(43) Pub. Date: Oct. 11, 2018

(54) ELECTROLYSIS SYSTEM, ELECTROLYSIS CONTROL APPARATUS, AND METHOD OF CONTROLLING AN ELECTROLYSIS SYSTEM

(71) Applicant: FUJITSU LIMITED, Kawasaki-shi (JP)

(72) Inventor: Hiroshi Nakao, Yamato (JP)

(73) Assignee: FUJITSU LIMITED, Kawasaki-shi (JP)

(21) Appl. No.: 15/942,852

(22) Filed: Apr. 2, 2018

(30) Foreign Application Priority Data
Apr. 7, 2017 (JP) 2017-076572

(51) Int. Cl. C25B 9/04; H02M 3/335; H02J 3/38; C25B 1/04; C25B 1/00; C25B 9/06; C25B 15/02

(52) U.S. Cl. CPC C25B 9/04; H02M 3/33507; H02J 3/385; C25B 15/02; C25B 1/003; C25B 9/06; C25B 1/04

(57) ABSTRACT

An electrolysis system includes a power generator configured to output a first direct current power; a plurality of DC-DC converters respectively configured to convert the first direct current power into a second direct current power and output voltage information and current information of the second direct current power; a plurality of electrolyzers respectively configured to receive the second direct current power output from a DC-DC converter and generate gas; a control circuit configured to output control information that maximizes the first direct current power based on a voltage value and a current value of the first direct current power; and a processor configured to output the target current value and a selection signal indicating whether or not to select each of the plurality of electrolyzers to each of the plurality of respective DC-DC converters, based on the control information, the voltage information and the current information.

### CROSS-REFERENCE TO RELATED APPLICATION

This application is based upon and claims the benefit of priority of the prior Japanese Patent Application No. 2017-76572, filed on Apr. 7, 2017, the entire contents of which are incorporated herein by reference.

### FIELD

The embodiments discussed herein are related to an electrolysis system, an electrolysis control apparatus, and a method of controlling an electrolysis system.

### BACKGROUND

Until now, techniques are known that use electrical energy generated by a solar battery for electrolyzing water in order to generate hydrogen (for example, refer to Japanese Laid-open Patent Publication No. 2007-31813 and Japanese Laid-open Patent Publication No. 2001-335982).

FIG. 1 is a diagram illustrating an example of the configuration of a hydrogen production system. A hydrogen production system 1001 illustrated in FIG. 1 includes a power conditioner 92 that converts a DC voltage (for example, direct current (DC) 400V) to an AC voltage (for example, alternating current (AC) 200V). When the power conditioner 92 is connected to a solar battery 91, the current flowing through an intermediate bus 93 is an alternating current. Accordingly, in order to connect a hydrogen electrolyzer 95, the alternating current has to be reconverted to a direct current by an AC-DC converter 94, and thus the power conversion efficiency deteriorates. Further, in order to raise the voltage generated by the hydrogen electrolyzer 95, the number of cells (the number of stacks) connected in series have to be increased. In this case, even if one of the cells connected in series deteriorates, and the internal resistance increases, deterioration of the cell progresses at an accelerating rate by heat generation. There is a risk of the hydrogen electrolyzer 95 becoming totally inoperable. In view of the above, it is desirable that the power conversion efficiency be improved, and continuous operation be possible at the same time even if deterioration occurs in an electrolyzer.

### SUMMARY

According to an aspect of the invention, an electrolysis system includes a power generator configured to output a first direct current power; a plurality of DC-DC converters respectively configured to convert the first direct current power into a second direct current power in accordance with an input target current value, and output voltage information and current information of the second direct current power; a plurality of electrolyzers respectively configured to receive the second direct current power output from one of the plurality of DC-DC converters and generate gas; a control circuit configured to output control information that maximizes the first direct current power based on a voltage value of the first direct current power and a current value of the first direct current power; and a processor configured to output the target current value and a selection signal indicating whether or not to select each of the plurality of electrolyzers to each of the plurality of respective DC-DC converters, based on the control information output from the control circuit, and the voltage information and the current information output from each of the plurality of DC-DC converters.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a hydrogen production system;

FIG. 2 is a diagram illustrating an example of the configuration of an electrolysis system according to the present disclosure;

FIG. 3 is a diagram illustrating an example of the current-voltage characteristic (IV characteristic) of a solar battery;

FIG. 4 is a diagram illustrating an example of the configuration of an MPPT controller by a hill climbing method;

FIG. 5 is a diagram illustrating an example of operation of the hill climbing method when a control target value is used for output current control;

FIG. 6 is a schematic diagram illustrating an example of a water electrolytic cell;

FIG. 7 is a diagram illustrating an example of the electrical characteristic of a water electrolytic cell;

FIG. 8 is a diagram illustrating an example of the configuration of a fixed-current control type DC-DC converter;

FIG. 9 is a diagram illustrating an example of the efficiency of the fixed-current control type DC-DC converter;

FIG. 10 is a diagram illustrating an example of the configuration of a cell selector;

FIG. 11 is a diagram illustrating an example of the configuration of a cell selector;

FIGS. 12A, 12B and 12C are diagrams illustrating an example in which lists are separately provided in a memory;

FIG. 13 is a diagram illustrating an example in which lists are provided as a structure in a memory;

FIG. 14 is a diagram illustrating an example of allocation (in the case of equal allocation) of a control target value;

FIG. 15 is a diagram illustrating an example of allocation (in the case where the largest number of converters are operated at Pmax) of a control target value;

FIG. 16 is a diagram illustrating an example of a cell attribute list;

FIG. 17 is a diagram illustrating efficiencies of the embodiment and comparative examples;

FIG. 18 is a diagram illustrating the configuration of a hydrogen production system according to a comparative example;

FIG. 19 is a diagram illustrating an example of allocation (the largest number of converters are operated at Pmax) of a control target value; and

FIG. 20 is a diagram illustrating an example of the configuration of an electrolysis system according to the present disclosure.

### DESCRIPTION OF EMBODIMENTS

In the following, a description will be given of embodiments of an electrolysis system according to the present disclosure.

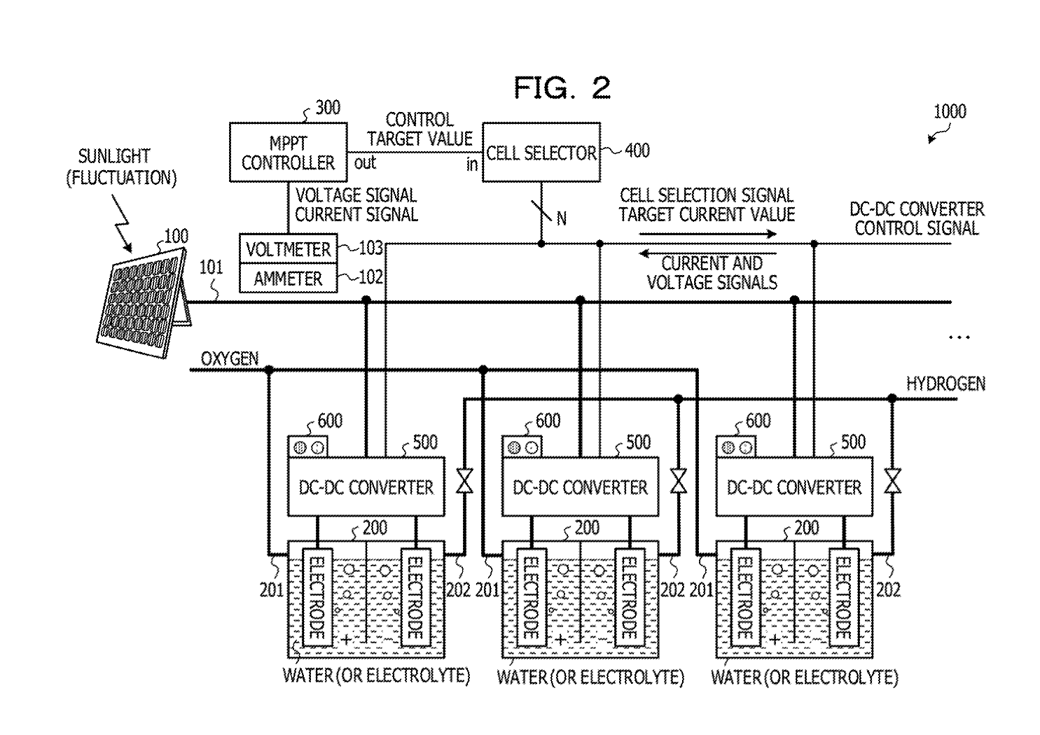

FIG. 2 is a diagram illustrating an example of the configuration of an electrolysis system according to the present disclosure. An electrolysis system 1000 illustrated in FIG. 2 electrolyzes water using the electrical energy generated by a solar panel 100 so as to generate hydrogen. The electrolysis system 1000 controls power extracted from the solar panel 100 such that the maximum power is output from the solar panel 100. The electrolysis system 1000 includes the solar panel 100, a plurality of DC-DC converters 500, a plurality of cells 200, and an electrolysis control apparatus. The electrolysis control apparatus controls the plurality of DC-DC converters 500 and the plurality of cells 200. The electrolysis control apparatus includes a maximum power point tracking (MPPT) controller 300 and a cell selector 400. The plurality of DC-DC converters 500 have the same configuration with each other. The plurality of cells 200 also have the same configuration with each other. In the following, a description will be given of each of the configurations, the functions, and the like.

The solar panel 100 is an example of a power generator that outputs generated first direct current power. The solar panel 100 includes a plurality of solar batteries arranged on a panel surface. The solar battery converts light energy, such as sunlight, into direct current power using the photovoltaic effect.

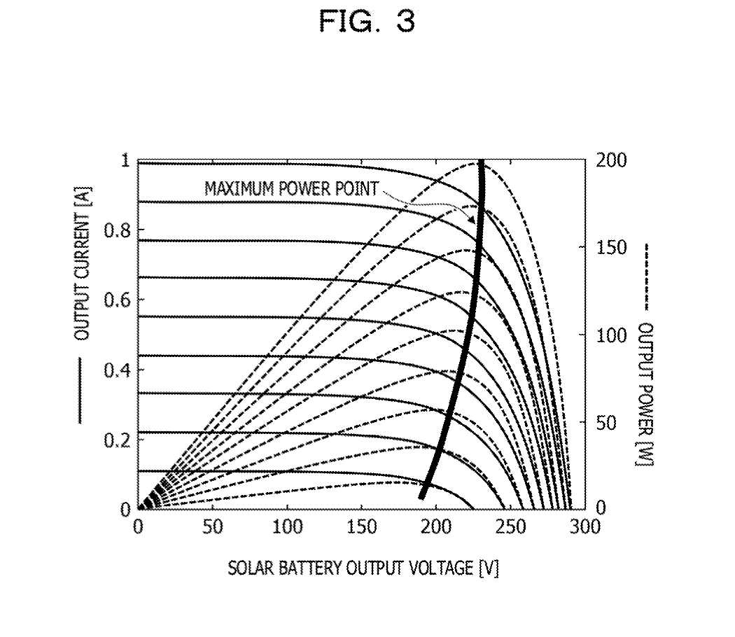

FIG. 3 is a diagram illustrating an example of the current-voltage characteristic (IV characteristic) of a solar battery. The solar battery has a current-voltage characteristic like that of a battery having a relatively large internal resistance, and thus a voltage drop occurs by drawing current. The maximum power point, which is determined by a current and a voltage at which the maximum power is extracted changes depending on the intensity of illumination on the solar battery and the temperature of the solar battery. When the intensity of illumination is high, the amount of power generation increases, and thus the maximum power increases. At the same time, if the temperature of a solar battery increases, the internal resistance increases, and thus the maximum power is reduced.

A method of controlling power extracted from a solar battery so as to meet the maximum power point all the time is called a maximum power point tracking (MPPT) control. In the MPPT control, a control method called a hill climbing method is often used. The MPPT control is an effective technique for using a solar battery at high efficiency. In the following, the output power at the maximum power point of the solar panel 100 is referred to as a maximum power Psolar_max.

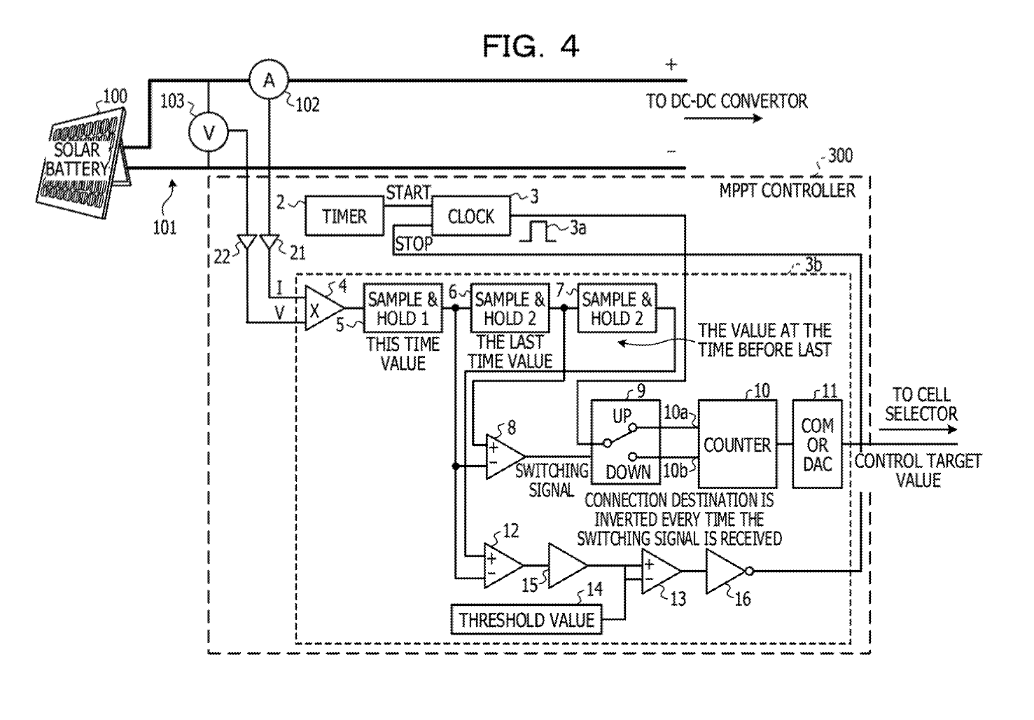

FIG. 4 is a diagram illustrating an example of the configuration of an MPPT controller by a hill climbing method. The MPPT controller 300 controls the control target value such that the output power of the solar panel 100, which is calculated by the ammeter 102 and the voltmeter 103 disposed on an output line 101 of the solar panel 100, becomes a maximum value. The control target value is an example of the control information that maximizes the output power of the solar panel 100. In the present embodiment, the MPPT controller 300 controls the control target value of the electrolyzer controller (specifically, the DC-DC converter 500) which is one of the loads of the solar panel 100.

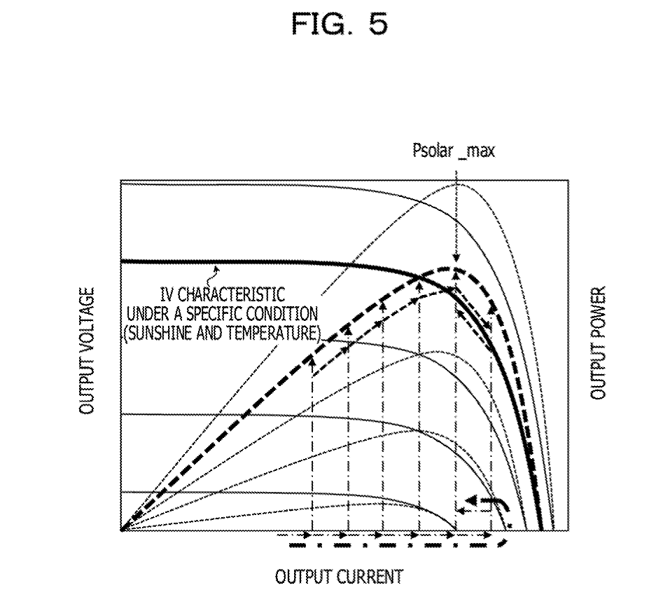

FIG. 5 is a diagram illustrating operation of the hill climbing method when a control target value is used for output current control. Next, a detailed description will be given of the configuration and the control operation of the MPPT controller 300 with reference to FIG. 4 and FIG. 5.

The MPPT controller 300 is a control circuit including a timer 2, a clock generator 3, and amplifiers 21 and 22. The MPPT controller 300 includes a multiplier 4, sample-and-hold circuits 5, 6, and 7, a comparator 8, a selector switch 9, an up-down counter 10, an interface circuit 11, a differential unit 12, an absolute value circuit 15, a comparator 13, and a stop-signal generation circuit 16.

The ammeter 102 measures the output current (the current flowing through the output line 101) of the solar panel 100. The voltmeter 103 measures the output voltage (the voltage applied to the output line 101) of the solar panel 100. The voltage signal denoted by a measured voltage value V and the current signal denoted by a current value I are input to the MPPT controller 300 via amplifiers 21 and 22 for amplitude adjustment if desired. The voltage value V denotes a voltage value of the output power of the direct current of the solar panel 100. The current value I denotes the current value of the output power of the solar panel 100.

The timer 2 denotes an interval timer that starts the operation of the MPPT controller 300. The timer 2 transmits a start signal (Start) of one pulse to the clock generator 3 once in a fixed time period (for example, on a 10-second period). When the clock generator 3 receives the start signal, the clock generator 3 generates and outputs a clock 3a of one pulse having a fixed period (for example, on a 100-millisecond period). The clock generator 3 then starts a circuit (a circuit 3b enclosed by a thin broken line) in synchronism with the clock 3a.

When the clock 3a is supplied to the circuit 3b, the voltage signal and the current signal are converted by the multiplier 4 to a power signal indicating a power value. The power signal indicating a power value is stored in the sample-and-hold circuit 5. A sample-and-hold unit includes cascade-connected three-stage sample-and-hold circuits 5, 6, and 7. The sample-and-hold circuits 5, 6, and 7 hold a power value corresponding to the clock 3a at this time, a power value corresponding to the clock 3a at the last time, and a power value corresponding to the clock 3a at the time before last respectively.

The comparator 8 compares the magnitudes of the power value corresponding to the clock 3a of this time with the power value corresponding to the clock 3a of the last time. If the power value of the current time is equal to or higher than the power value of the last time, the comparator 8 holds the state of the selector switch 9 in a current state. On the other hand, if the power value of the current time is less than the power value of the last time, it is estimated that the control target value has changed in a direction in which the output power of the solar panel 100 decreases, and thus the comparator 8 transmits a switching signal to the selector switch 9. When the selector switch 9 receives the switching signal, the selector switch 9 changes the connection destination of the clock 3a from the current connection destination.

If the clock 3a sent from the selector switch 9 is input to an up port 10a, the up-down counter 10 increments the counter value by one. On the other hand, if the clock 3a sent from the selector switch 9 is input to a down port 10b, the up-down counter 10 decrements the counter value by one. Further, the up-down counter 10 outputs the current counter value to the cell selector as a control target value via the interface circuit 11.

For example, in the case of digital communication, the interface circuit 11 is a communication port that converts a control target value to a digital communication signal. In the case of transmission using an analog voltage signal, the interface circuit 11 is a digital-to-analog converter that converts a control target value to an analog voltage. In the following, the communication port is referred to as a communication (“COM”), and the digital-to-analog converter is referred to as a digital-to-analog converter (“DAC”).

The differential unit 12 outputs the difference between a power value (value from the sample-and-hold circuit 5) corresponding to the clock 3a at this time and a power value (value from the sample-and-hold circuit 7) corresponding to the clock 3a at the time before last. The absolute value circuit 15 outputs the absolute value of the difference. When the absolute value of the difference obtained by the absolute value circuit 15 becomes lower than a threshold value 14 determined in advance, the comparator 13 determines that the output power of the solar panel 100 has reached the maximum power point and causes the stop-signal generation circuit 16 to generate a clock stop signal (Stop). When the clock generator 3 receives the clock stop signal generated by the stop-signal generation circuit 16, the clock generator 3 stops outputting the clock 3a regardless of whether or not the start signal is received. Thereby, the MPPT control of the MPPT controller 300 is stopped.

In the stop period of the MPPT control of the MPPT controller 300, the up-down counter 10 continues outputting the control target value immediately before the stop of the MPPT controller 300.

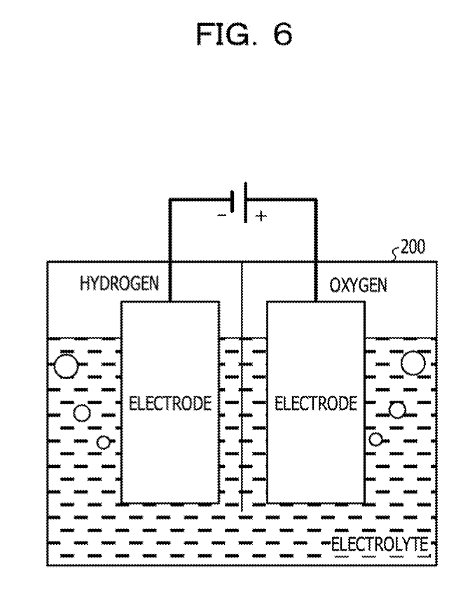

FIG. 6 is a schematic diagram illustrating an example of a water electrolytic cell. The cell 200 is also referred to as a water electrolytic cell or an electrolyzer. When a DC voltage is applied to water, electrolysis occurs, and gas (specifically, oxygen and hydrogen) is generated. The generated oxygen is released into the atmosphere or stored via an oxygen pipe 201 (refer to FIG. 2). The generated hydrogen is stored via a hydrogen pipe 202 (refer to FIG. 2). The stored hydrogen is used as energy.

The cell 200 is an example of an electrolyzer that receives input of the direct current output from a corresponding DC-DC converter 500 and generates gas, such as hydrogen, or the like. There are various types of water electrolytic cell, such as an alkaline water type, a high temperature steam type, a high molecular polymer type, or the like.

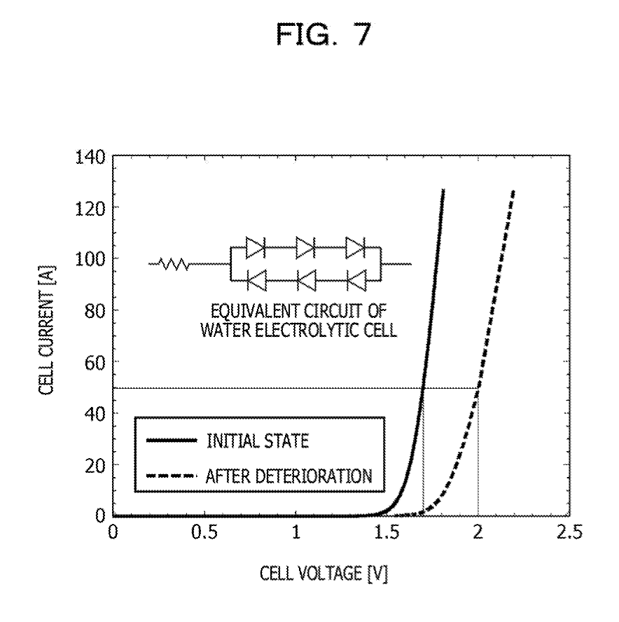

FIG. 7 is a diagram illustrating an example of the electrical characteristic of a water electrolytic cell. A water electrolytic cell has a current-voltage characteristic, such as a diode. In a water electrolytic cell, a current suddenly starts to flow from a threshold value voltage of about 1 to 1.5 V, and electrolysis is started (refer to a solid line in FIG. 7). When a water electrolytic cell is continuously used, the resistance of the water electrolytic cell increases due to deterioration of an electrode, and the current becomes hard to flow (refer to a broken line in FIG. 7).

In hydrogen production by solar power generation, input power to a water electrolytic cell changes drastically. Accordingly, it is desirable to use a normal temperature operation type electrolyzer capable of reducing deterioration in the power efficiency even at the time of a low power. The cell current of a water electrolytic cell changes greatly with respect to a change in the cell voltage of the water electrolytic cell. Accordingly, it is desirable to perform fixed current control in which a current flowing through the water electrolytic cell is kept fixed rather than fixed voltage control in which a voltage applied to the water electrolytic cell is kept fixed.

If a water electrolytic cell in a several kW class or more is used as a single cell, a cell current becomes too high (up to thousands amperes), and thus it becomes difficult to wiring the cells. Accordingly, single cells are stacked up in tens to hundreds of stages so that it is possible to raise the total operation voltage and to decrease the cell current.

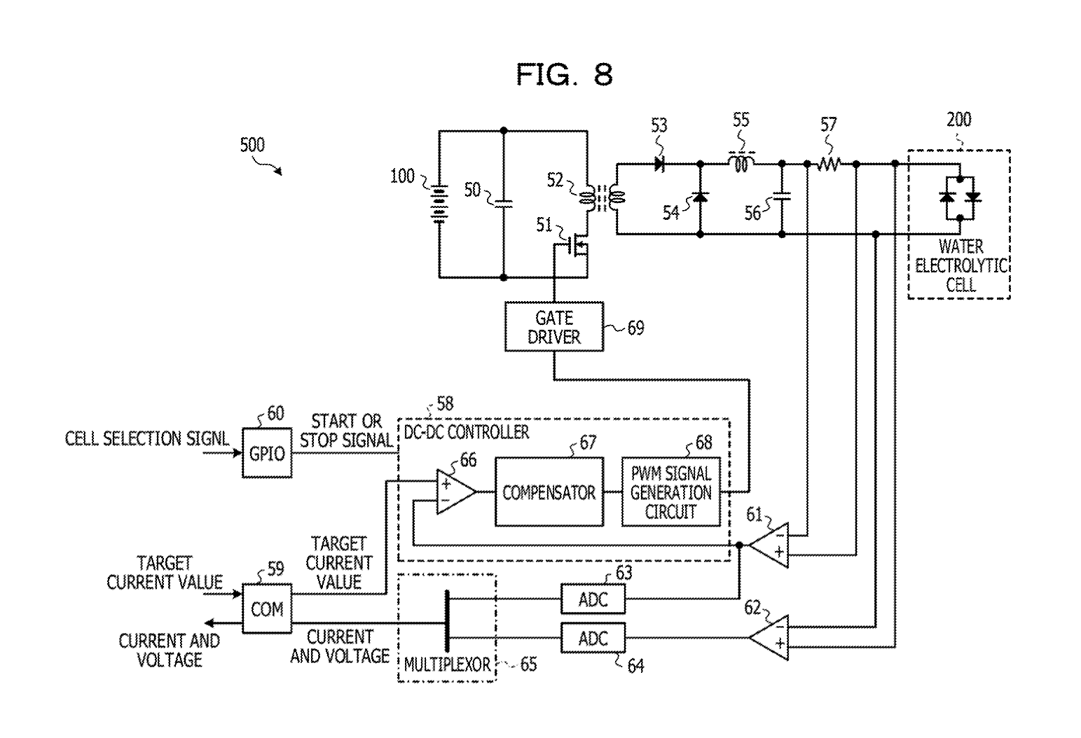

FIG. 8 is a diagram illustrating an example of the configuration of a fixed-current control type DC-DC converter. FIG. 8 illustrates an example of the configuration of each of the plurality of DC-DC converters 500 illustrated in FIG. 2. The DC-DC converter 500 is an example of the converter. The DC-DC converter 500 is an example of the fixed-current control type DC-DC converter that keeps the output current to be supplied to the cell 200 at a fixed value. The plurality of DC-DC converters 500 individually convert the first direct current power output by the solar panel 100 to a second direct current power in accordance with the input target current value. The plurality of DC-DC converters 500 then individually output the voltage information of the second direct current power and the current information of the second direct current power.

The DC-DC converter 500 illustrated in FIG. 8 includes a capacitor 50, a switch 51, a transformer 52, diodes 53 and 54, an inductor 55, a capacitor 56, a current detection resistor 57, a current detection circuit 61, and a voltage detection circuit 62. The DC-DC converter 500 includes analog-to-digital converters (ADCs) 63 and 64, a DC-DC controller 58, a gate driver 69, a multiplexer 65, a communication port (COM) 59, and a general-purpose input and output port GPIO port) 60.

The DC-DC converter 500 transmits the power generated by a plurality of solar batteries in the solar panel 100 via the transformer 52 by turning on and off by the switch 51. The DC-DC converter 500 rectifies the power transmitted via the transformer 52 by the diodes 53 and 54, then levels the power using the inductor 55 and the capacitor 56, and supplies the power to the cell 200.

The DC-DC controller 58 performs pulse width modulation (PWM) control of the on time of the switch 51 by the gate driver 69 such that the current value of the output current supplied to the cell 200 matches the target current value supplied from the cell selector 400 via the communication port 59. The current value of the output current supplied to the cell 200 is detected, for example, by amplification, using the amplifier of the current detection circuit 61, of the voltage that occurs across both ends of the current detection resistor 57 through which the output current flows.

The DC-DC controller 58 includes, for example, an error amplifier 66, a compensator 67, and a PWM signal generation circuit 68. The error amplifier 66 calculates the error between the target current value and the detected current value. The compensator 67 generates a duty ratio control value that controls the duty ratio of the DC-DC converter 500 so that the error becomes zero. The duty ratio of the DC-DC converter 500 refers to the duty ratio of the switching of the switch 51. The PWM signal generation circuit 68 outputs a PWM signal in accordance with the duty ratio control value generated by the compensator 67. The gate driver 69 performs switching of the switch 51 in accordance with the PWM signal output from the PWM signal generation circuit 68.

The DC-DC converter 500 has a function of transmitting a voltage value of the output voltage applied to the cell 200 and a current value of the output current flowing through the cell 200 via the communication port 59 for the purpose of management of the state of the cell 200. For example, an ADC 63 converts the analog current value detected by the amplifier of the current detection circuit 61 to a digital current detection value and output the digital value, and an ADC 64 converts the analog voltage value detected by the amplifier of the voltage detection circuit 62 to a digital voltage detection value and outputs the digital value. The multiplexer 65 transmits the current detection value output from the ADC 63 and the voltage detection value output from the ADC 64 to the cell selector 400 via the COM 59 (refer to FIG. 2).

The DC-DC converter 500 has a function of changing the start and the stop of the DC-DC converter 500 based on the cell selection signal received from the cell selector 400 (refer to FIG. 2) via the general-purpose input and output port 60.

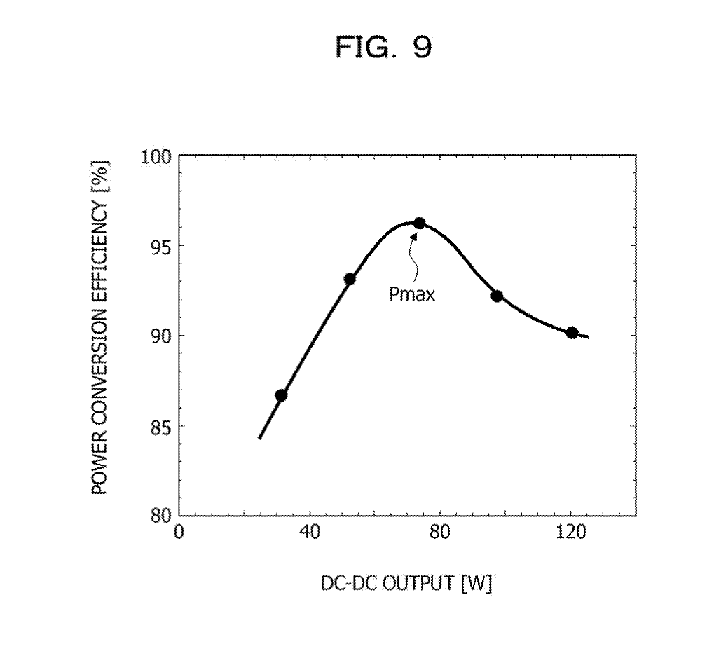

FIG. 9 is a diagram illustrating an example of the efficiency of the fixed-current control type DC-DC converter. On a high output side in which the output power of the DC-DC converter is relatively high, the power conversion efficiency of the DC-DC converter deteriorates due to an increase in the resistance loss. On the other hand, on a low output side in which the output power of the DC-DC converter is relatively low, the power conversion efficiency of the DC-DC converter deteriorates due to a fixed loss of the control circuit and a switching loss caused by on and off of the switch. Hereinafter a power at which the power conversion efficiency becomes a maximum is denoted by a maximum efficiency power Pmax.

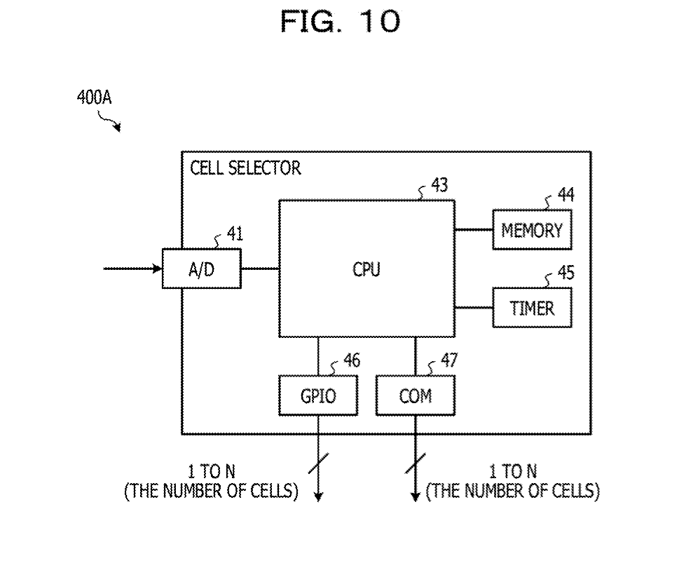

FIG. 10 is a diagram illustrating an example of the configuration of the cell selector when the control target value output from the MPPT controller 300 is an analog voltage. The cell selector 400A illustrated in FIG. 10 is an example of the cell selector 400 illustrated in FIG. 2. The cell selector 400A includes an AD converter (A/D) 41, a central processing unit (CPU) 43, a memory 44, a timer 45, a general-purpose input and output port (GPIO) 46, and a communication port (COM) 47. The A/D 41 receives input of the control target value output from the MPPT controller 300 (refer to FIGS. 2 and 4).

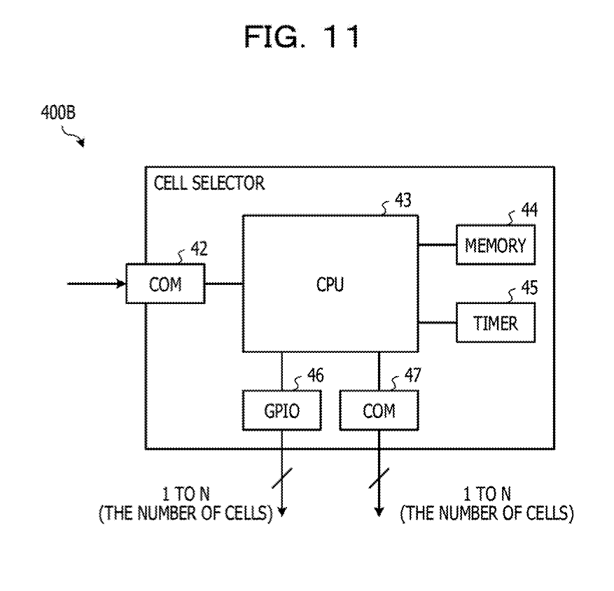

FIG. 11 is a diagram illustrating an example of the configuration of the cell selector when the control target value output from the MPPT controller 300 is digital. The cell selector 400B illustrated in FIG. 11 is an example of the cell selector 400 illustrated in FIG. 2. The cell selector 400B includes a communication port (COM) 42, a CPU 43, a memory 44, a timer 45, a general-purpose input and output port (GPIO) 46, and a communication port (COM) 47. The COM 42 receives input of the control target value output from the MPPT controller 300 (refer to FIGS. 2 and 4).

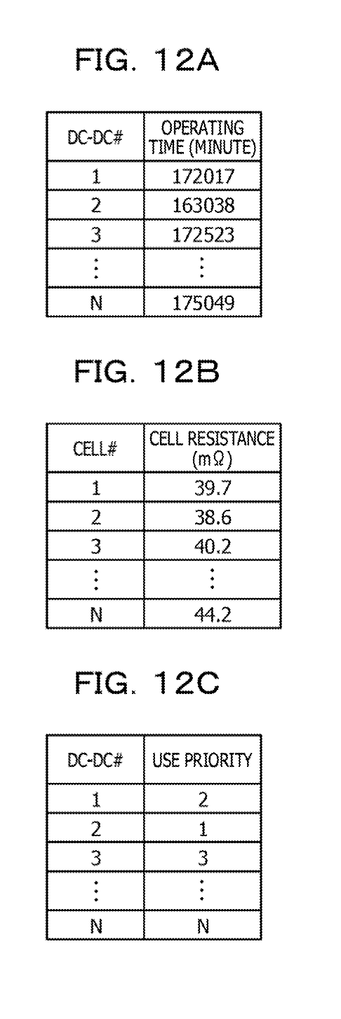

FIGS. 12A, 12B and 12C are diagrams illustrating an example in which lists are separately provided in a memory. In the memory 44 of the cell selector 400, for example, an operating time list (FIG. 12A), a cell resistance list (FIG. 12B), and a use priority list (FIG. 12C) are stored. In the operating time list, the operating time (in other words, the operating time (energization time) of each of the plurality of cells 200) of each of the plurality of (N pieces of) DC-DC converters 500 are stored. In the cell resistance list, the cell resistance value of each of the plurality of (N pieces of) cells 200 are stored. In the use priority list, the use priority (in other words, the use priority of each of the plurality of cells 200) of the plurality of DC-DC converters 500 are stored. The higher the use priority of the DC-DC converter 500 (or the cell 200), the more preferentially the DC-DC converter 500 is used.

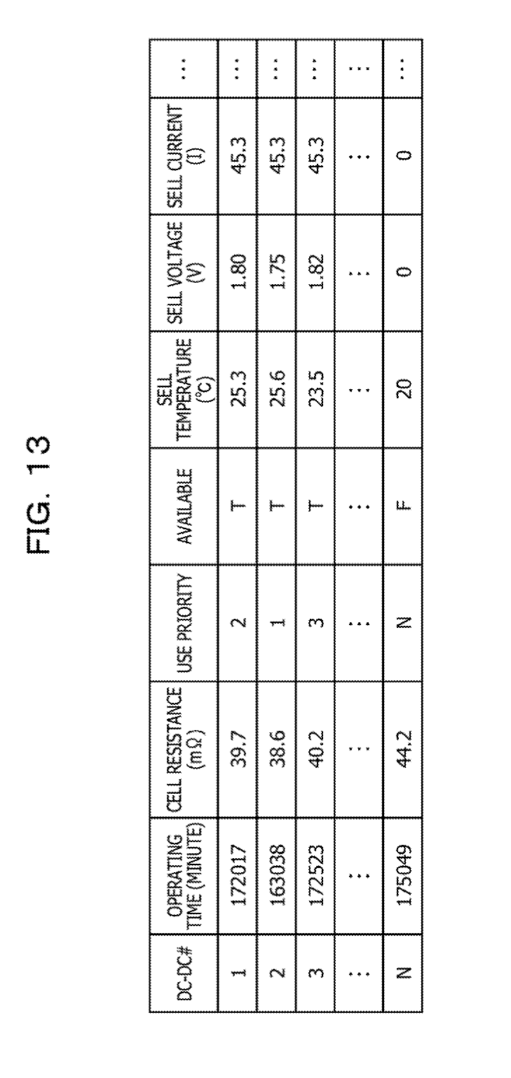

FIG. 13 is a diagram illustrating an example in which lists are provided as a structure in a memory. As illustrated in FIG. 13, in the memory 44 of the cell selector 400, for example, operating time, cell resistance value, use priority, availability, cell temperature, cell voltage, cell current, and the like are stored for each of the plurality of DC-DC converters 500 (in other words, the plurality of cells 200). In the column of availability, T denotes available, and F denotes unavailable.

The cell selector 400 illustrated in FIG. 2 is an example of the selector. The cell selector 400 outputs a target current value and a cell selection signal for each of the plurality of DC-DC converters 500 based on the control target value output by the MPPT controller 300 and the voltage information and the current information that are output by each of the plurality of DC-DC converters 500. The cell selection signal is an example of the selection signal that determines whether or not each of the plurality of cells 200 (may be the plurality of DC-DC converters 500) is selected to be used.

The cell selector 400 has a function of maximizing the power conversion efficiency of the entire electrolysis system 1000. For example, the CPU 43 (refer to FIGS. 10 and 11) of the cell selector 400 performs processing for outputting a target current value and the cell selection signal such that the maximum power Psolar_max output from the solar panel 100 is equally allocated and input to any of the plurality of DC-DC converters 500. Thereby, it is possible to avoid concentratedly supplying the maximum power Psolar_max on any one of the plurality of DC-DC converters 500. The CPU 43 of the cell selector 400 receives the control target value that moves the output power of the solar panel 100 to the maximum power point from the MPPT controller 300 so as to obtain the maximum power Psolar_max.

The CPU 43 of the cell selector 400 performs processing for outputting a target current value and a cell selection signal, for example, such that the maximum power Psolar_max is equally allocated to (int(Psolar_max/Pmax)+1) DC-DC converters 500 using the maximum efficiency power Pmax. That is to say, (Psolar_max/(int(Psolar_max/Pmax)+1)) is input to each of the (int(Psolar_max/Pmax)+1) DC-DC converters 500. Int(*) denotes an integer obtained when the decimal places of * are rounded down. Thereby, it is possible to supply power to each of the int(Psolar_max/Pmax)+1) DC-DC converters 500 within the maximum efficiency power Pmax as the upper limit value. As a result, it is possible to improve the power conversion efficiency of each of the int(Psolar_max/Pmax)+1) DC-DC converters 500.

A maximum efficiency power Pmax denotes a power at which the DC-DC converter 500 has the maximum power conversion efficiency. A maximum efficiency power Pmax is stored in the memory 44 of the cell selector 400 (refer to FIGS. 10 and 11) in a readable manner by the CPU 43 in advance.

The CPU 43 of the cell selector 400 may perform the processing for outputting the target current value and the cell selection signal such that the maximum power Psolar_max is allocated to any of the plurality of DC-DC converters 500, and the number of the DC-DC converters 500 to which the maximum efficiency power Pmax is input becomes the maximum number. That is to say, the cell selector 400 allocates the maximum efficiency power Pmax to int(Psolar_max/Pmax) DC-DC converters 500, and the remaining power (Psolar_max−int(Psolar_max/Pmax)×Pmax) is allocated to another DC-DC converter 500. Thereby, it is possible to maximize the number of DC-DC converters 500 to which the maximum efficiency power Pmax is input, and thus the power conversion efficiency of the entire electrolysis system 1000 is improved.

The cell selector 400 has a function of leveling the operating time of each of the plurality of DC-DC converters 500 or the plurality of cells 200. The CPU 43 of the cell selector 400 records the value (count time) produced by counting the operation time of the DC-DC converter 500 that performs fixed current control on a normally operated cell 200 (the energization time of the cell 200) using the timer 45 in the memory 44. Thereby, the operating time list is created in the memory 44. The CPU 43 of the cell selector 400 refers to the created operating time list and determines that the shorter the operating time of a cell, the longer of the remaining lifetime of the cell (not deteriorated). The CPU 43 outputs a selection signal that selects use of the cell such that a cell having the shortest operating time is preferentially operated. Thereby, it is possible to perform leveling of the operating time of each of the plurality of cell 200, and thus to avoid the progress of deterioration of part of the cells 200 excessively.

The CPU 43 of the cell selector 400 calculates the cell resistance value of each of the plurality of cells 200 based on the current value and the voltage value that are collected from each of the plurality of DC-DC converters 500 via the COM 47 and records the cell resistance value in the memory 44. Thereby, the cell resistance list is created in the memory 44. The CPU 43 of the cell selector 400 refers to the created cell resistance list and determines that the lower the cell resistance value of a cell, the longer the remaining life (not deteriorated) of the cell. The CPU 43 outputs a selection signal for selecting use of the cell such that a cell having the lowest cell resistance value is preferentially operated. Thereby, it is possible to perform leveling the cell resistance value of each of the plurality of cells 200, and thus it is possible to avoid excessive deterioration of a part of the cells 200.

The CPU 43 of the cell selector 400 determines that a cell 200 having a cell resistance value higher than a predetermined threshold value has deteriorated. The cell selector 400 outputs, for example, a cell selection signal for stopping the operation of the DC-DC converter 500 that controls the current supplied to the deteriorated cell 200 in order to stop the use of the deteriorated cell 200 via the GPIO 46 (refer to FIGS. 10 and 11). The CPU 43 of the cell selector 400 causes an alarm device 600 (refer to FIG. 2) to set off an alarm corresponding to a cell 200 having the cell resistance value higher than a threshold value among the plurality of cells 200. By setting off an alarm using light, sound, or the like, it is possible for a user to identify a deteriorated cell.

### First Embodiment

In the first embodiment, a case where the solar panel 100 includes five solar batteries having the output voltage at the time of no load of 150 to 300V and the maximum output of 200 W that are connected in parallel, and thus it is assumed that the solar panel 100 has the maximum power Psolar_max of 1 kW is illustrated in FIG. 2. In the first embodiment, it is assumed that the cells 200 have a configuration in which 13 single cells having the maximum input of 100 W are connected in parallel.

In the first embodiment, the MPPT controller 300 outputs the maximum power Psolar_max (0 to 1 kW) at the time of MPPT control correspondingly to a 12-bit digital signal of 1 to 4096 as a control target value to be sent to the cell selector 400 via the communication port of the interface circuit 11.

In the first embodiment, the cell selector 400 calculates a target current value to be instructed to each of the DC-DC converters 500 by the CPU 43 based on the control target value received via the COM 47. Here, the CPU 43 of the cell selector 400 converts the target current value to be instructed to the DC-DC converter 500 into a digital value on the assumption that the rated maximum current IMax of the DC-DC converter 500 is defined as 100.

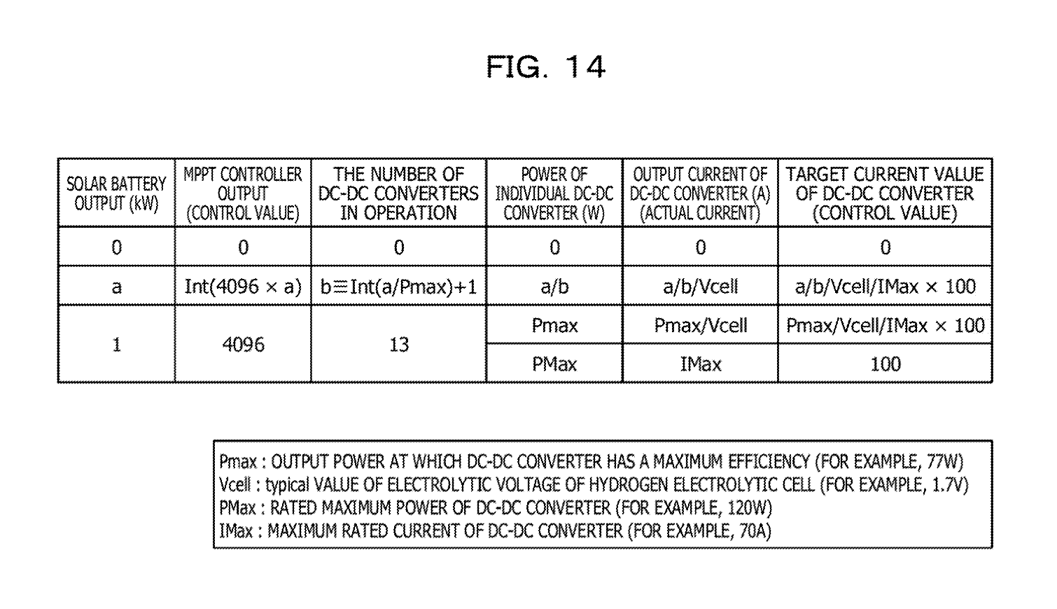

FIG. 14 is a diagram illustrating an example of allocation of a control target value (in the case of equal allocation). FIG. 14 illustrates the case where the cell selector 400 outputs the target current value and the cell selection signal such that the maximum power Psolar_max is equally allocated and input to the (int(Psolar_max/Pmax)+1) DC-DC converters 500 using the maximum efficiency power Pmax. In this case, the cell selector 400 determines the number of DC-DC converters 500 to be operated and target current values that are instructed to the individual DC-DC converters 500 in accordance with the relationship illustrated in FIG. 14.

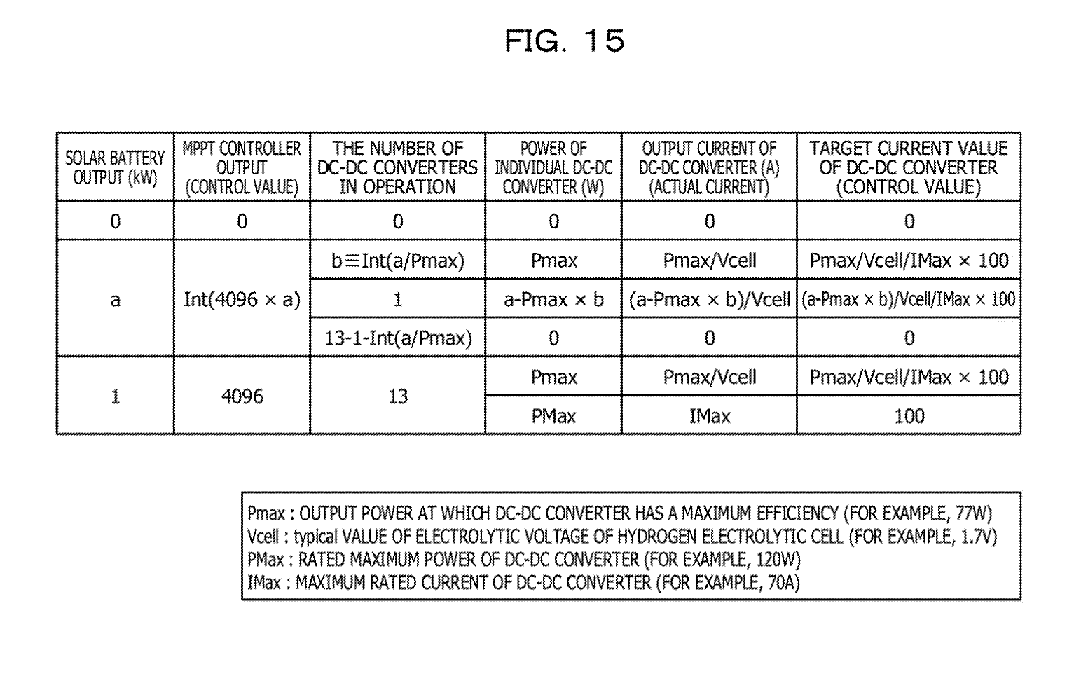

FIG. 15 is a diagram illustrating an example of allocation of a control target value (the largest number of converters are operated at Pmax). FIG. 15 illustrates the case where the cell selector 400 outputs a target current value and a cell selection signal such that the maximum power Psolar_max is allocated to any of the plurality of DC-DC converters 500, and the number of the DC-DC converters 500 that receive input of the maximum efficiency power Pmax becomes maximum. In this case, the cell selector 400 determines the number of DC-DC converters 500 to be operated and target current values that are instructed to the individual DC-DC converters 500 in accordance with the relationship illustrated in FIG. 15.

Next, the cell selector 400 outputs a cell selection signal indicating which of the plurality of DC-DC converters 500 and the plurality of cells 200 are to be operated in accordance with the attribute of each of the plurality of cells 200 recorded in the memory 44. As a specific example of the attribute of the cell 200, use time of the cell 200, a cell resistance value of the cell 200, and the like are given.

For example, the CPU 43 of the cell selector 400 refers to the attribute of each of the plurality of cells 200 and determines the use priority of the cell 200. The CPU 43 of the cell selector 400 outputs a selection signal that instructs the individual DC-DC converters 500 to use cells in descending order of the use priority and the target current value of each of the cells 200. The CPU 43 of the cell selector 400 starts the timer 45 and measures the operating time (use time) of each of the cells 200 or DC-DC converters 500.

In FIG. 8, the DC-DC converter 500 that has been started by receiving a cell selection signal from the GPIO 60 controls the current flowing through the cell 200 based on the target current value transmitted via the COM 59. The DC-DC converter 500 transmits an AD converted value of the current detection value of the current detected by the current detection circuit 61 and an AD converted value of the voltage detection value of the voltage detected by the voltage detection circuit 62 to the cell selector 400 via the COM 59.

The cell selector 400 calculates a cell resistance value by the CPU 43 based on the current detection value and the voltage detection value transmitted from each of the DC-DC converters 500 and records the values in the cell attribute list in the memory 44.

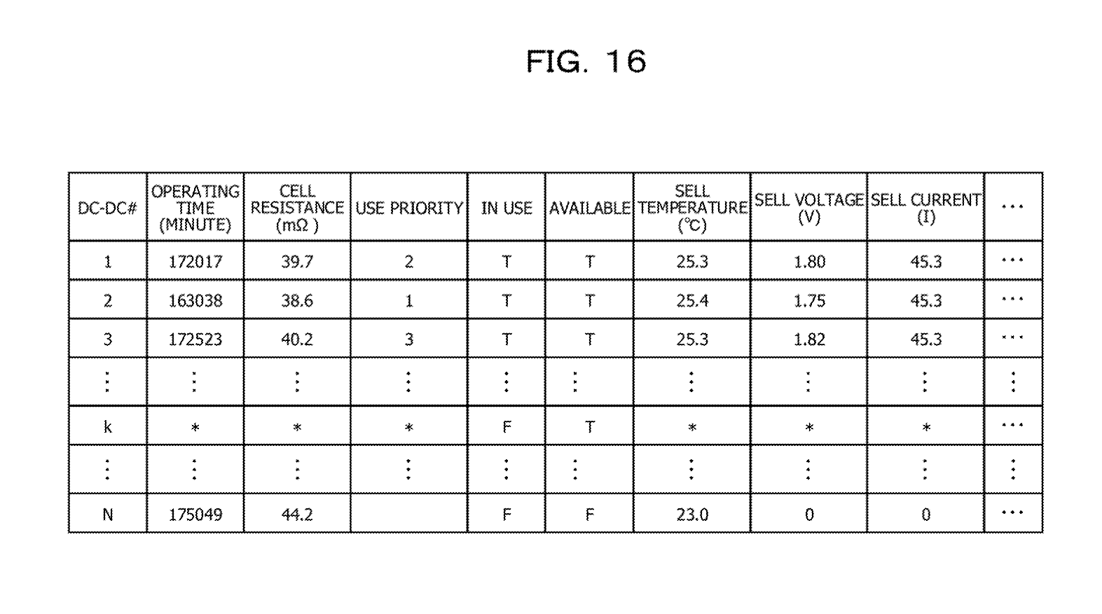

FIG. 16 is a diagram illustrating an example of a cell attribute list. The cell selector 400 reads operating time of each of the cells 200 from the timer 45 and updates the operating time stored in the cell attribute list. The cell selector 400 also updates the cell resistance value with the latest value with the update of the operating time. The cell selector 400 updates the use priority of the cell 200 based on the operating time or the cell resistance value. The shorter the operating time or the lower the cell resistance value, the higher use priority the cell selector 400 sets.

When the cell selector 400 performs the above-described control for equally allocating the control target value, the cell selector 400 calculates and updates the cell resistance value every time the current value and the voltage value of the cell 200 are obtained. Thereby, it is possible to suitably determine the use priority of the cell 200. Alternatively, when the cell selector 400 performs the above-described control for operating the largest number of the DC-DC converters 500 with the maximum efficiency power Pmax, the cell selector 400 calculates and updates the cell resistance value of the cell 200 controlled by the DC-DC converter 500 operating with the maximum efficiency power Pmax. Thereby, it is possible to suitably determine the use priority of the cell 200.

When the cell selector 400 increases the number of cells 200 to be operated due to a change of the control target value provided from the MPPT controller 300, the cell selector 400 selects a cell 200 having the highest use priority as a cell to be newly operated among the stopped cells 200. On the other hand, when the cell selector 400 decreases the number of cells 200 to be operated due to a change of the control target value provided from the MPPT controller 300, the cell selector 400 selects a cell 200 having the lowest use priority as a cell to be stopped among the cells 200 in operation. Thereby, it is possible to equalize the burden on the cells against load variations.

In the case of performing the above-described control for operating the largest number of cells at Pmax, when the cell selector 400 changes the number of cells 200 to be operated due to a change of the control target value provided from the MPPT controller 300, the cell selector 400 selects the cells to be operated at power other than Pmax as follows. The cells operated at power other than Pmax refers to the cells (cells operated at a power lower than Pmax) that are controlled by the DC-DC converters 500 to which the remaining power (Psolar_max−int(Psolar_max/Pmax)×Pmax) have been allocated. When the cell selector 400 increases the number of cells 200 to be operated, the cell selector 400 selects a cell 200 having the highest use priority among the stopped cells 200 as a cell operated at a power other than Pmax. On the other hand, when the cell selector 400 decreases the number of cells 200 to be operated, the cell selector 400 selects a cell 200 having the lowest use priority among the cells 200 in operation as a cell to be operated by the power other than Pmax. Thereby, it is possible to equalize the burden on the cells against load variations.

The cell attribute list illustrated in FIG. 16 records operating time, a cell current, a cell voltage, and a cell resistance value of a cell or a DC-DC converter. However, the cell attribute list may store a temperature of a cell, or the like. Thereby, it is possible for the cell selector 400 to monitor the operation state of each of the cells 200 more in detail. In FIG. 16, in the column of “in use”, T denotes “in use”, and F denotes “not in use”. In FIG. 16, in the column of “available”, T denotes available, and F denotes unavailable.

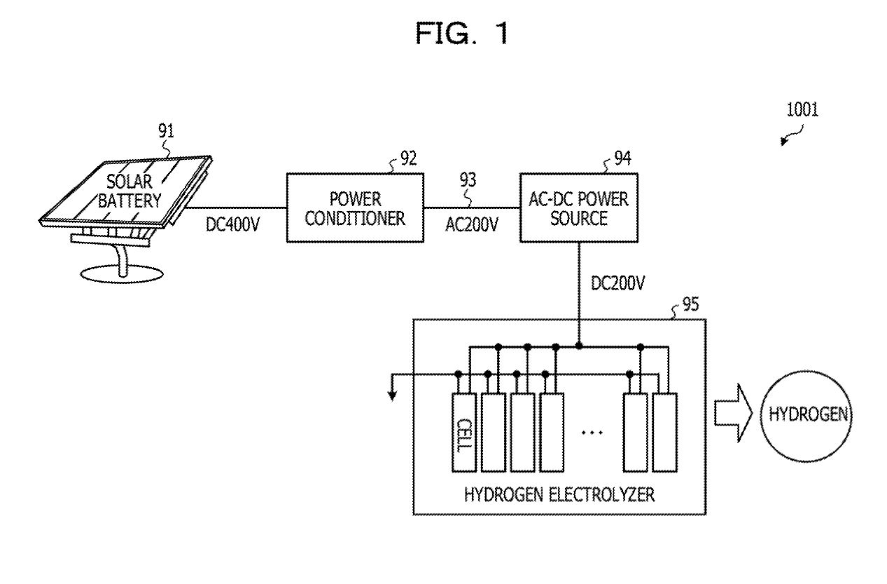

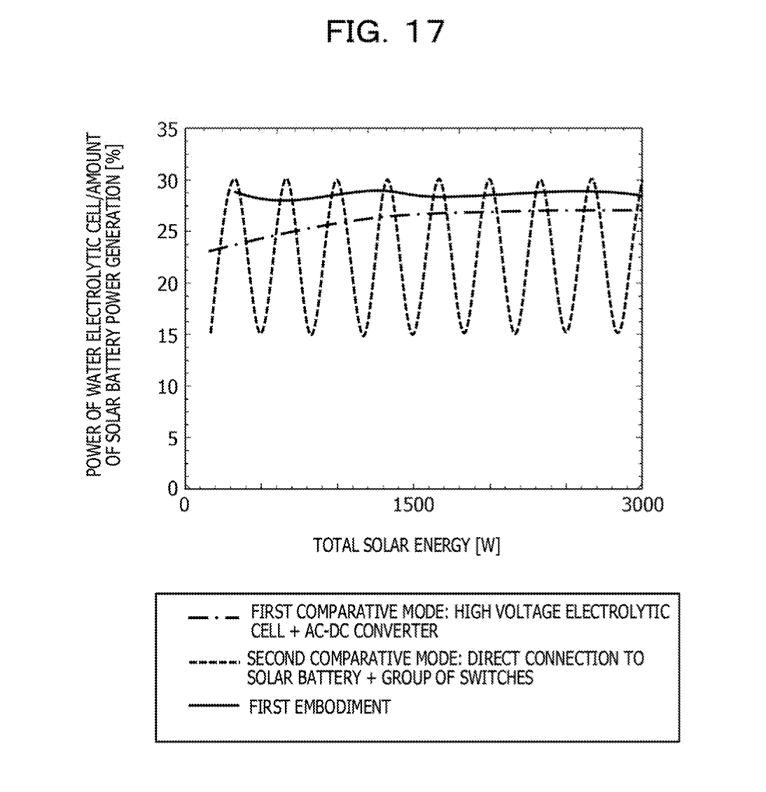

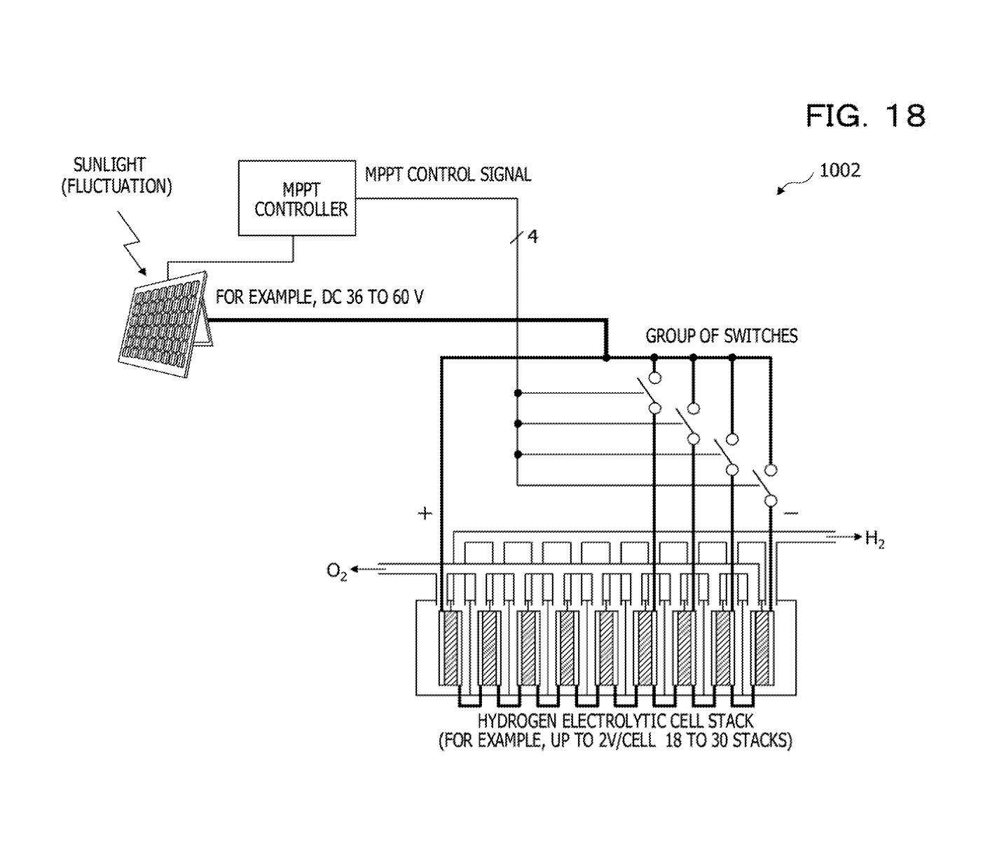

FIG. 17 is a diagram illustrating efficiencies of the embodiment and comparative examples. The vertical axis in FIG. 17 represents a value of the power conversion efficiency including the power generation efficiency 30% of the solar battery. A comparative mode 1 represents a graph in the case of a system of a mode illustrated in FIG. 1. A comparative mode 2 represents a graph in the case of a system of a mode illustrated in FIG. 18.

FIG. 18 is a diagram illustrating the configuration of a hydrogen production system according to the comparative example. In the configuration of a hydrogen production system 1002 illustrated in FIG. 18, the power conditioner is not provided unlike the case of FIG. 1, and the solar battery and the hydrogen electrolytic cell stack are directly connected via a switch group. The MPPT controller changes the number of stacks to be operated by changing four switches included in the switch group.

As illustrated in FIG. 17, the maximum value of the power conversion efficiency in the comparative mode 2 is higher than that in the first embodiment and the comparative mode 1. However, the efficiency deteriorates in periods of changing connections of cells by switches included in the switch group in the comparative mode 2. In contrast, in the configuration of the first embodiment, it is possible to keep the high efficiency over a wide range.

### Second Embodiment

It is possible to determine the remaining life of the cell 200 by a cell resistance value. The cell selector 400 corrects the current target value supplied to the DC-DC converter 500 using a cell resistance value Rcell of the cell 200. Thereby, even if a cell 200 deteriorates, and the cell resistance value increases, it is possible to operate the DC-DC converter 500 at the maximum efficiency power Pmax. Accordingly, it is possible to reduce deterioration of the power conversion efficiency of the entire electrolysis system.

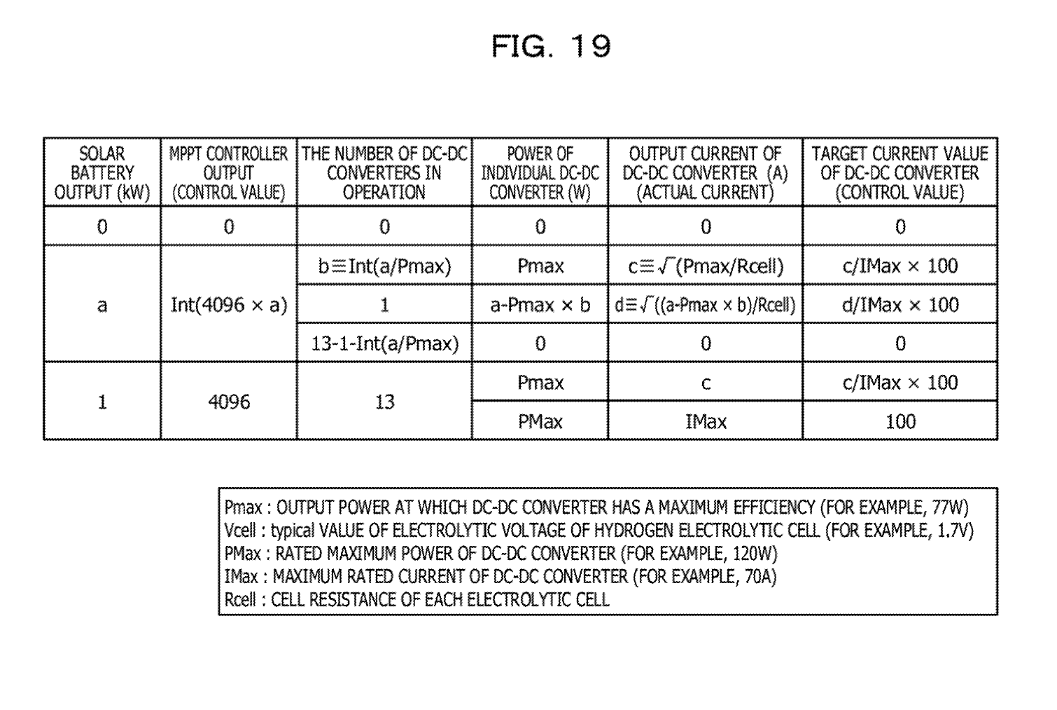

FIG. 19 is a diagram illustrating an example of allocation of a control target value (the largest number of converters are operated at Pmax). FIG. 19 illustrates the case where the cell selector 400 outputs a target current value and a cell selection signal such that the maximum power Psolar_max is allocated to any of the plurality of DC-DC converters 500, and the largest number of DC-DC converters 500 receive input of the maximum efficiency power Pmax. In this case, the cell selector 400 determines the number of DC-DC converters 500 to be operated and the target current value instructed to each of the DC-DC converters 500 in accordance with the relationship illustrated in FIG. 19. In FIG. 15, the current is defined using the cell voltage Vcell. However, in FIG. 19, the current is defined using the cell resistance value Rcell. In this manner, the cell selector 400 corrects the current target value supplied to the DC-DC converter 500 by the cell resistance value Rcell of the cell 200.

### Third Embodiment

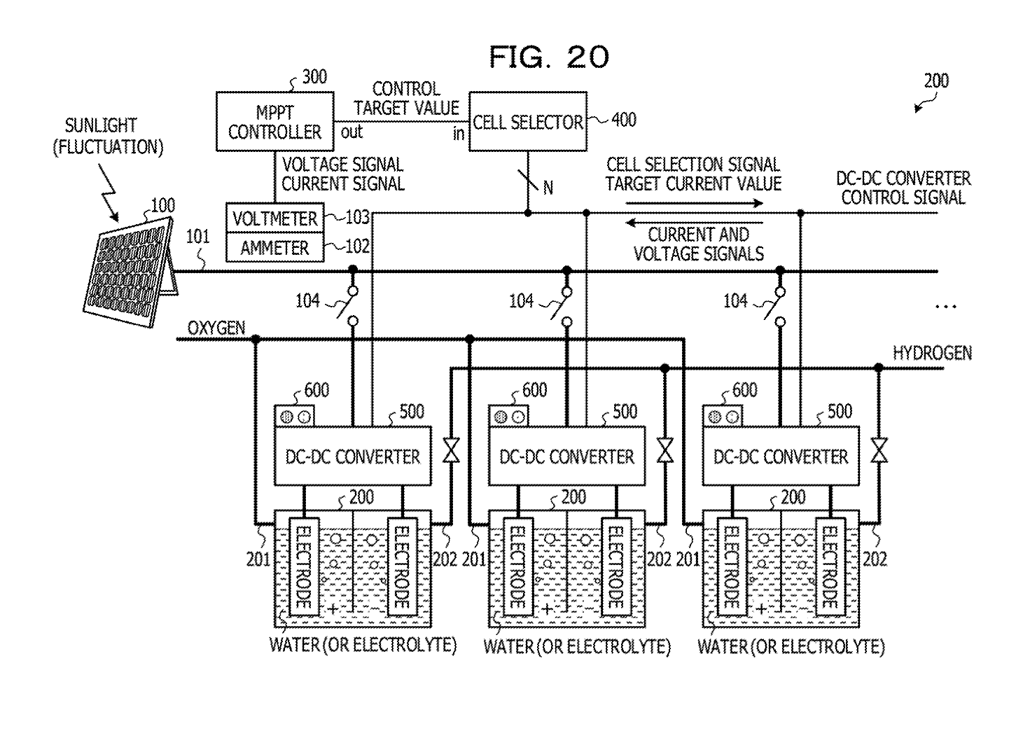

FIG. 20 is a diagram illustrating an example of the configuration of an electrolysis system according to the present disclosure. In an electrolysis system 2000, which is illustrated in FIG. 20, according to a third embodiment, an operation example in the case where a specific cell deteriorates and becomes unavailable is illustrated.

The cell selector 400 stops a cell 200 having a resistance value higher than a predetermined stop determination threshold value among the plurality of cells 200. When the cell selector 400 decreases the number of cells 200 to be operated, for example, due to a change of the control target value provided from the MPPT controller 300, the cell selector 400 stops a cell having a resistance value higher than a stop determination threshold value. The cell selector 400 then writes the unavailable flag (“F” in the available column in FIG. 16) in the cell attribute list.

The cell selector 400 separates a cell to be stopped from the electrolysis system 2000. For example, the cell selector 400 stops the DC-DC converter 500 that controls the cell using the cell selection signal and/or separates a DC-DC converter 500 that controls the cell to be stopped from the output line 101 using a breaker 104.

The cell selector 400 may set off the alarm indicating deterioration of cell to be stopped. The cell selector 400 may continue operation of the cell until the cell is maintained.

If Psolar_max is lower than or equal to (Pmax×(the number of available cells)), the CPU 43 of the cell selector 400 continues the operation by a method of the first embodiment or the second embodiment. On the other hand, if Psolar_max is higher than (Pmax×(the number of available cells)), the CPU 43 of the cell selector 400 operates all the available cells at (Psolar_max/(the number of available cells)). Since the DC-DC converter 500 is originally operated at the maximum efficiency power Pmax lower than the rated maximum power PMax, overload does not occur in the power range lower than or equal to PMax.

At the point in time when the maintenance of a deteriorated cell is complete, the cell operating time, the cell resistance value, and the unavailable flag are manually or automatically initialized in the cell attribute list, and the operation of the cell is returned.

According to the third embodiment, even if individual cells deteriorate and become unavailable, it is possible to continue operating the electrolysis system 2000 itself and to improve the operation efficiency.

In the above, descriptions have been given of the electrolysis system, the electrolysis control apparatus, and the method of controlling an electrolysis system. However, the present disclosure is not limited to the embodiments described above. It is possible to make various variations and improvement, such as a combination or replacement of a part of or all of the other embodiments, and the like within the scope of the present disclosure.

For example, the power generator is not limited to an apparatus that generates power using sunlight, which is one kind of renewable energy. The power generator may be an apparatus that generates power using the other renewable energy, such as wind power, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electrolysis system comprising:
a power generator configured to output a first direct current power;
a plurality of DC-DC converters respectively configured to convert the first direct current power into a second direct current power in accordance with an input target current value, and output voltage information and current information of the second direct current power;
a plurality of electrolyzers respectively configured to receive the second direct current power output from one of the plurality of DC-DC converters and generate gas;
a control circuit configured to output control information that maximizes the first direct current power based on a voltage value and a current value of the first direct current power; and
a processor configured to output the target current value and a selection signal indicating whether or not to select each of the plurality of electrolyzers to each of the plurality of DC-DC converters, based on the control information output from the control circuit, and the voltage information and the current information output from each of the plurality of DC-DC converters.

2. The electrolysis system according to claim 1,
wherein the processor is configured to output the target current value and the selection signal such that the maximum first direct current power output by the power generator is equally allocated and input to any of the plurality of DC-DC converters.

3. The electrolysis system according to claim 2,
wherein the processor is configured to output the target current value and the selection signal such that the maximum first direct current power output by the power generator is equally allocated and input to any of the plurality of DC-DC converters using a power at which a maximum power conversion efficiency is obtained.

4. The electrolysis system according to claim 2, wherein the processor is configured to
when the number of electrolyzers to be operated is increased, select an electrolyzer having highest use priority among stopped electrolyzers, and
when the number of electrolyzers to be operated is decreased, select an electrolyzer having lowest use priority among electrolyzers in operation.

5. The electrolysis system according to claim 1,
wherein the processor is configured to output the target current value and the selection signal such that the maximum first direct current power output by the power generator is equally allocated to any of the plurality of DC-DC converters, and a largest number of DC-DC converters receive input of power having a maximum power conversion efficiency.

6. The electrolysis system according to claim 5,
wherein the processor is configured to:
when the number of electrolyzers to be operated is increased, select an electrolyzer having highest use priority among stopped electrolyzers as an electrolyzer operating by power other than power at which a maximum power conversion efficiency is obtained, and
when the number of electrolyzers to be operated is decreased, select an electrolyzer having lowest use priority among electrolyzers in operation as an electrolyzer operating by power other than power at which a maximum power conversion efficiency is obtained.

7. The electrolysis system according to claim 1,
wherein the processor is configured to output the selection signal in accordance with an attribute of each of the plurality of electrolyzers.

8. The electrolysis system according to claim 7,
wherein the attribute is a resistance value.

9. The electrolysis system according to claim 8,
wherein the processor is configured to output the selection signal such that the lower the resistance value of an electrolyzer, the more preferentially the electrolyzer is operated among the plurality of electrolyzers.

10. The electrolysis system according to claim 7,
wherein the attribute is operating time.

11. The electrolysis system according to claim 10,
wherein the processor is configured to output the selection signal such that the shorter the operating time of an electrolyzer, the more preferentially the electrolyzer is operated among the plurality of electrolyzers.

12. The electrolysis system according to claim 1,
wherein the processor is configured to correct the target current value in accordance with a resistance value of each of the plurality of electrolyzers.

13. The electrolysis system according to claim 1,
wherein the processor is configured to set off an alarm corresponding to an electrolyzer having a resistance value higher than a threshold value among the plurality of electrolyzers.

14. The electrolysis system according to claim 1,
wherein the processor is configured to stop an electrolyzer having a resistance value higher than a threshold value among the plurality of electrolyzers.

15. An electrolysis control apparatus that controls a plurality of DC-DC converters and a plurality of electrolyzers, the electrolysis control apparatus comprising:
a control circuit configured to output control information that maximizes a first direct current power output from a power generator, based on a voltage value and a current value of the first direct current power; and
a processor configured to output the target current value and a selection signal indicating whether or not to select each of the plurality of electrolyzers to each of the plurality of DC-DC converters, based on the control information output from the control circuit, and voltage information and current information of a second direct current power produced by converting the first direct current power in accordance with a target current value, having been output from each of the plurality of DC-DC converters.

16. A control method executed by an electrolysis system including a power generator configured to output a first direct current power, the control method comprising:
converting, by each of a plurality of DC-DC converters, the first direct current power into a second direct current power in accordance with an input target current value; outputting voltage information and current information of the second direct current power;
receiving, by each of a plurality of electrolyzers, the second direct current power output from one of the plurality of DC-DC converters and generating gas;
outputting, by a control circuit, control information that maximizes the first direct current power based on a voltage value and a current value of the first direct current power; and
outputting, by a processor, the target current value and a selection signal indicating whether or not to select each of the plurality of electrolyzers to each of the plurality of DC-DC converters, based on the control information output from the control circuit, and the voltage information and the current information output from each of the plurality of DC-DC converters.
